(19) United States
(12) Patent Application Publication
(10) Pub. No.: US 2003/0115098 A1
(43) Pub. Date: Jun. 19, 2003

(54) Advertisement system and method

(75) Inventor: Do-Woo Kang, Kunpo (KR)

Correspondence Address: FLESHNER & KIM, LLP, P.O. BOX 221200, CHANTILLY, VA, 20153, US

(73) Assignee: LG Electronics Inc.

(21) Appl. No.: 10/207,954

(22) Filed: Jul. 31, 2002

(30) Foreign Application Priority Data
Dec. 15, 2001 (KR) 79764/2001

(51) Int. Cl. G06F 17/60

(52) U.S. Cl. 705/14

(57) ABSTRACT

An intelligent advertisement system and method are provided which utilize a GPS phone capable of grasping a present position of a user and outputting information and advertisements corresponded to major interests of users to an advertisement medium within a pertinent region. The intelligent advertisement system includes a mobile communication terminal for inputting and transmitting personal information including major interests of a user and tracked by GPS (global positioning system) satellites, an advertisement processing unit for collecting the personal information transmitted from the mobile communication terminal and controlling an output of advertisements according to priority, and an advertisement medium for outputting advertisements related to major interests of users according to the control of the advertisement processing unit. By providing advertisements according to advertisement demands variable by time and place, advertisement efficiency can be improved, effect of advertisements can be improved through varied advertisement demands data, and the data can be used as marketing information.

### BACKGROUND OF THE INVENTION

1. Field of the Invention

The invention relates to an advertisement system and method. More particularly, the invention relates to an intelligent advertisement system and method.

2. Background of the Related Art

With the spread of mobile communication terminals, services receivable through mobile communication terminals have expanded. For example, with the development of high-quality mobile communication terminals, a mobile communication base station provides not only a voice communication service but also various contents such as stock, weather, sports, entertainment and current events, etc.

With the increase in terminal usage time and frequency, service providers have sought a method of providing advertisements through the mobile communication terminal. Accordingly, it is possible to provide various advertisements sponsored by advertisers from a mobile communication base station to mobile communication terminal users through a mobile communication network.

FIG. 1 is a block diagram illustrating an advertisement system using a mobile communication terminal in accordance with the prior art. The conventional advertisement system includes a mobile communication terminal 10, a base station 20 that connects the mobile communication terminal 10 to an advertisement providing unit 40, and a sponsor 30 that requests the advertisement providing unit 40 to advertise.

The advertisement providing unit 40 includes an exchanger 41 that connects the mobile communication terminal 10 to the advertisement providing unit 40, an information server 42 that stores information collected from the sponsor 30 and a position information server 43 that stores the present position information of the mobile communication terminal 10. The information server 42 provides advertisements to the mobile communication terminal 10 and counts the number of advertisements provided to the mobile communication terminal 10.

The operation of the conventional advertisement system using the mobile communication terminal will be described below.

When a user operates a keypad of the mobile communication terminal 10 in order to receive advertisements, the exchanger 41 recognizes it through the base station 20. The information server 42 recognizes an identification number of the mobile communication terminal 10. The position information server 43 recognizes a present position of the mobile communication terminal 10 through the exchanger 41 and performs a customer position registration. The information server 42 provides advertisement information to the mobile communication terminal 10 using a voice service or a short message service and stores an advertisement acceptance mileage, such as the number of provided advertisements and an advertisement providing time, etc. of each mobile communication terminal 10.

The mobile communication terminal 10 receiving advertisements provided from the information server 42 may have a partial exemption of the telephone call charge or free telephonic communication times according to the mileage. In other words, the user receives a reduction in the telephone call charge.

The conventional advertisement method using the mobile communication terminal will be described in more detail with reference to FIG. 2. The user of the mobile communication terminal 10 contacts the information server 42 by inputting a specific telephone number, as shown at step S11. When the user of the mobile communication terminal 10 contacts the information server 42, the information server 42 provides at least one voice advertisement (a first˜a nth advertisement) to the user of the mobile communication terminal 10, as shown at step S12.

For example, when four advertisements are serially provided to a user during one contact and the time of one advertisement is 10˜15 seconds, the user can listen and watch an announcement and advertisements for 50˜70 seconds. The advertisements may be a voice format or short message format.

After a certain time has passed, the information server 42 judges whether the advertisement service has ended, as shown at step S13. When it is judged that the advertisement service has ended, the information server 42 stores an advertisement acceptance mileage, such as the number of advertisements and advertisement time, etc. of a pertinent mobile communication terminal 10, as shown at step S14. The advertisement service ends when the user presses a certain key of the mobile communication terminal during the advertisement service or when all the advertisements selected by the user have been provided.

The information server 42 then provides a benefit to the user of the mobile communication terminal 10, such as a telephone call charge reduction or free telephonic communication time according to the advertisement acceptance mileage, as shown at step S15. In more detail, with respect to a telephone call charge reduction, when a reduction of 25 cents per advertisement is provided, if the user hears four advertisements, the user can receive a one dollar reduction in the telephone call charge. The above-mentioned compensation service can be varied according to the advertisement companies providing the advertisement services.

Accordingly, in the conventional advertisement method using the mobile communication terminal, the user may receive a reduction in telephone call charge by hearing a voice advertisement or receiving a short message type advertisement service from the communication service provider. When the mobile communication terminal user accepts the advertisement service, a free call time corresponding to the number or a time of the received advertisements is given to the pertinent mobile communication terminal user.

However, in the conventional advertisement system and method using a mobile communication terminal, by providing voice advertisements and message type advertisements considering only a present position and personal information of terminal users, advertisements irrelevant to the interests of a user may be indiscriminately provided to the user. Accordingly, an advertisement efficiency may be lowered. In addition, in the conventional advertisement system and method using a mobile communication terminal, because advertisements are provided to users only through mobile communication terminals, advertisement efficiency is difficult to establish. That is, because it is difficult to establish whether a user hears or checks an advertisement message provided according to a request of the user, a preference of a sponsor is low. Accordingly, contents of advertisements are limited to the public interest or news, etc.

The above references are incorporated by reference herein where appropriate for appropriate teachings of additional or alternative details, features and/or technical background.

### SUMMARY OF THE INVENTION

An object of the invention is to solve at least the above problems and/or disadvantages in whole or in part and to provide at least the advantages described hereinafter.

Accordingly, it is an object of the invention to provide an intelligent type advertisement system and method using a mobile communication terminal which are capable of providing selective advertisements through advertisement mediums installed at places at which users are located on the basis of personal information of the users using GPS (global positioning system) phones.

In order to achieve at least the above-mentioned objects, in whole or in part, and in accordance with the purposes of the invention, as embodied and broadly described, an improvement, in an advertisement system using a mobile communication terminal in accordance with an embodiment of the invention, is provided wherein advertisements are outputted in real time through an advertisement medium in a region based on a priority determined by collecting major interests of users of GPS (global positioning system) phones tracked by GPS (global positioning system) satellites within the region.

To further achieve at least the above objects in whole or in part and in accordance with the purposes of the invention, as embodied and broadly described, an advertisement system using one or more mobile communication terminals according to an embodiment of the invention is provided which includes one or more mobile communication terminals configured to receive and transmit information corresponding to users of the one or more mobile communication terminals, an advertisement processing unit for collecting the information transmitted from the one or more mobile communication terminals, and controlling an output of advertisements according to a priority based on the information and an advertisement medium configured to output the advertisements related to the information of the users under the control of the advertisement processing unit.

To further achieve at least the above objects in whole or in part and in accordance with the purposes of the invention, as embodied and broadly described, an advertisement method, in an advertisement system having one or more mobile communication terminals, an advertisement processing unit configured to collect information of users of the one or more mobile communication terminals and an advertisement medium configured to display advertisements, according to an embodiment of the invention is provided that includes determining advertisement demands through users of the one or more mobile communication terminals within a region, and outputting advertisements through the advertisement medium within the region according to the advertisement demands.

To further achieve at least the above objects, in whole or in part, and in accordance with the purposes of the invention, as embodied and broadly described, an advertisement method using one or more mobile communication terminals according to an embodiment of the invention is provided that includes selecting and storing information of one or more mobile communication terminals, collecting the information of the users of the one or more mobile communication terminals, and outputting advertisements through an advertisement medium within a region according to an order of priority based on the collected information.

To further achieve at least the above objects, in whole or in part, and in accordance with the purposes of the invention, as embodied and broadly described, an advertisement method using one or more mobile communication terminals according to an embodiment of the invention is provided that includes selecting and storing items of information by users of the one or more mobile communication terminals, judging whether the users of the one or more mobile communication terminals go into a region in which an advertisement medium is installed, collecting information of the users going into the region, determining an order of priority in the collected information, and outputting advertisements to the advertisement medium within the region based on the order of priority.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. The invention will be described in detail with reference to the following drawings in which like reference numerals refer to like elements wherein:

FIG. 1 is a block diagram illustrating an advertisement system using a mobile communication terminal in accordance with the prior art;

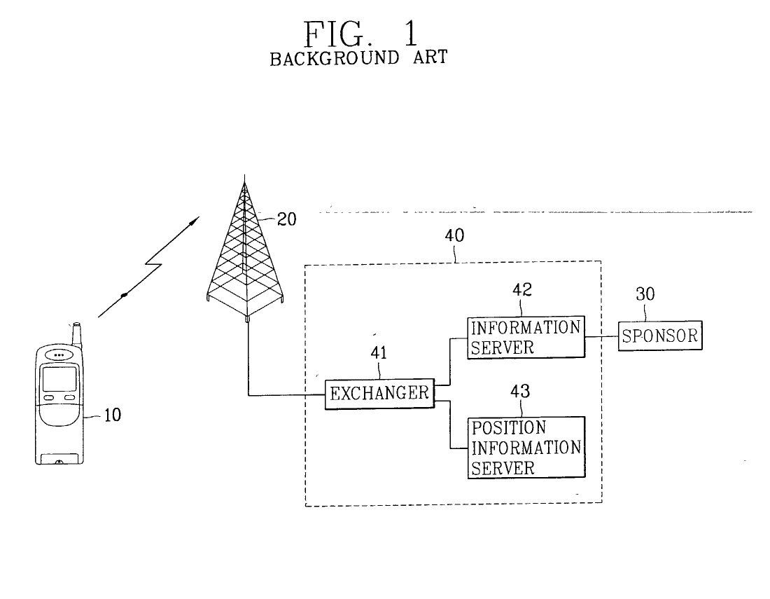

FIG. 2 is a flow chart illustrating an advertisement method using a mobile communication terminal in accordance with the prior art;

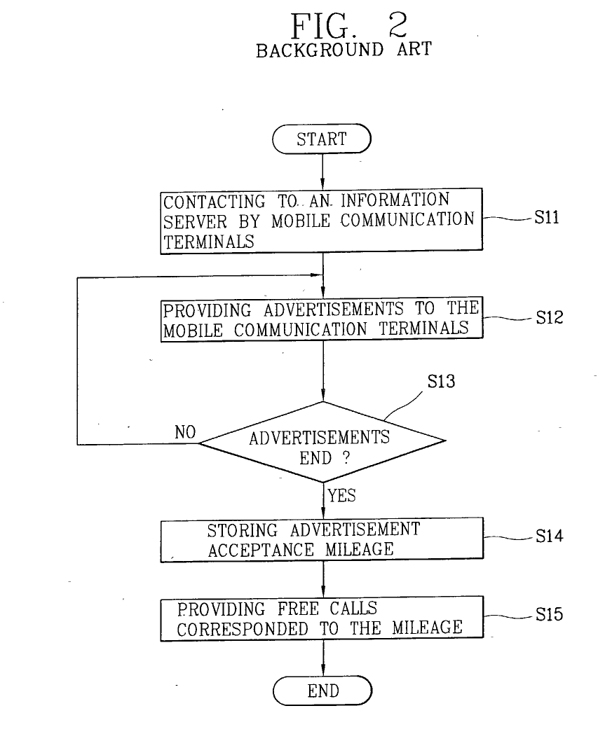

FIG. 3 is a block diagram illustrating an advertisement system using a mobile communication terminal in accordance with an embodiment of the invention; and

FIG. 4 is a flow chart illustrating an advertisement method using a mobile communication terminal in accordance with an embodiment of the invention.

### DETAILED DESCRIPTION OF PREFERRED EMBODIMENTS

Hereinafter, an advertisement system and method using a mobile communication terminal in accordance with embodiments of the invention will be described in detail with reference to accompanying drawings.

Generally, a GPS (global positioning system) is a military system developed by the U.S. Department of Defense of the U.S. to measure the positions of objects on the earth. The GPS measures a present position of an object by receiving radio waves using a GPS receiver installed on the subject. Twenty-four GPS satellites (actually, twenty-seven including three sub-satellites) respectively revolve around the earth in different orbits. It is possible to receive not less than four satellite signals at any time anywhere on the earth. A more accurate position value could be obtained by receiving more signals from more satellites.

The GPS is used as the navigation device for airplanes, ships, and other various vehicles together with an electronic map. It is also used for determining a position of a moving body, such as a vehicle, etc. In addition, a mobile communication terminal having a GPS receiver has been developed and put on the market.

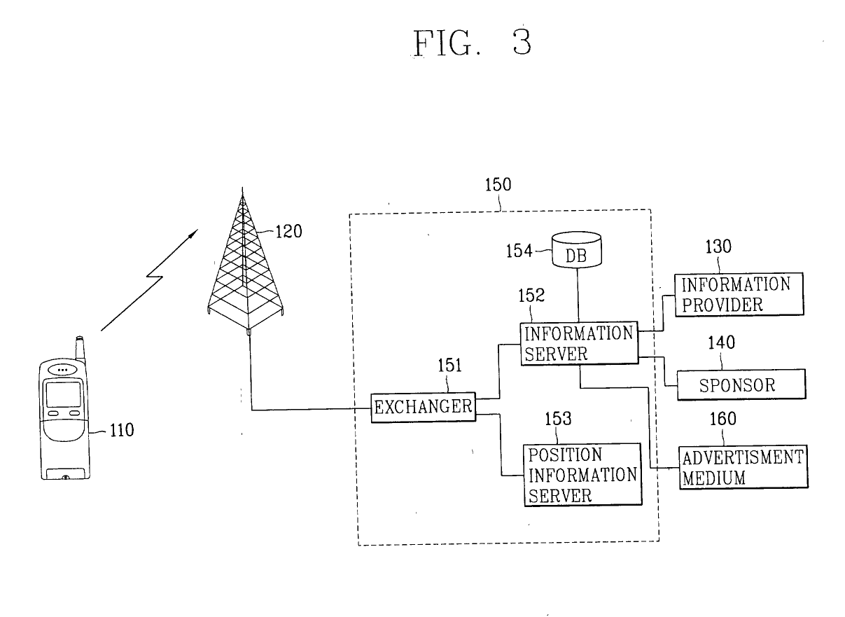

FIG. 3 illustrates an intelligent advertisement system using a mobile communication terminal in accordance with an embodiment of the invention. As depicted in FIG. 3, the intelligent advertisement system includes one or more GPS phone(s) 110 having a GPS receiver, a base station 120 for connecting to the GPS phone 110, an advertisement processing unit 150, an information provider 130 that provides information related to advertisements of the advertisement processing unit 150, a sponsor 140 that provides advertisements to the advertisement processing unit 150, and an advertisement medium 160 that displays the provided advertisements. In FIG. 3, only one GPS phone 110 is shown; however, it should be understood that multiple users using multiple GPS phones 110 may be serviced.

The advertisement processing unit 150 according to an embodiment of the invention may include an exchanger 151 that connects the GPS phone 110 to the advertisement processing unit 150, an information server 152 that stores information collected from the sponsor 140 and the information provider 130, a position information server 153 that stores present position information of the mobile communication terminal, and a database 154 that stores personal information of a user of the GPS phone 110.

The GPS phone 110 transmits a present position including data corresponding to its latitude and longitude by processing data received from GPS satellites. In addition, the GPS phone 110 can transmit various other data information, such as personal data, major interests of a user, etc.

The information server 152 stores advertisements requested by the sponsor 140 and various other information related to the advertisement. The database 154 collects and stores personal information of the user, such as name, age, sex, hobby, job, major interests etc. Personal information of the user may be inputted through, not only a GPS phone, but also other communication means, such as the Internet. The advertisement medium 160 is an advertisement means installed at a department store, a whole-sale mart, a street, in a mall, on or in a subway, on a billboard, etc., which receives advertisements instantly. For example, the advertisement medium may be a display device, such as an information screen, an electronic billboard, a monitor, a plasma display device, a liquid crystal display, or other conveyor of visual information.

The operation of the intelligent advertisement system using the mobile communication terminal in accordance with embodiments of the invention will be described in detail below.

The user of the GPS phone 110 inputs personal information, including, for example, major interests of the user, through the GPS phone 110 or the Internet. The user may update the personal information and major interests as occasion demands.

When the GPS phone 110 transmits the personal information and a present position of the GPS phone 110, the personal information is stored in the database 154, and the position information of the GPS phone 110 is stored in the position information server 153. The present position of the GPS phone 110 is an absolute value extracted from data corresponding to pertinent latitude and longitude data.

By the above-mentioned method, personal information data is collected. Then, information and advertisements related to major interests of the user of the GPS phone 110 within an advertisement area are extracted from the information server 152. Interests of users of GPS phone(s) 110 within the advertisement area are continually collected and updated.

The advertisements extracted from the information server 152 are transmitted through a pertinent advertisement medium 160 in an advertisement region in real time. By using the GPS phone 110, a present position of the user is accurately determined, and information and advertisements corresponding to major interests of the user in an advertisement area ate instantly provided to the pertinent advertisement medium 160.

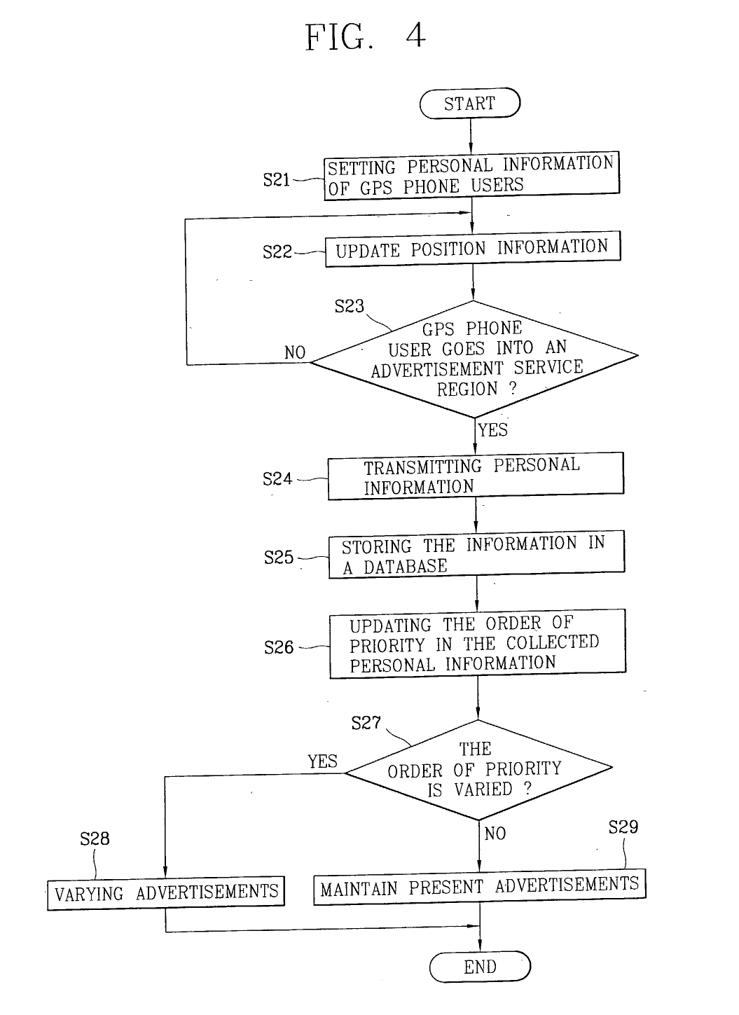

FIG. 4 is a flow chart illustrating an intelligent advertisement method using a mobile communication terminal in accordance embodiment of the invention. As depicted in FIG. 4, a user of a GPS phone 110 initializes the GPS phone 110 as a mobile communication means tracked by GPS satellites by inputting personal information, as shown at step S21. The personal information may include name, age, sex, hobby, interest fields, etc. of the user. The user may update the personal information as needed.

The exchanger 151 recognizes a position of the GPS phone 110 by recognizing a wireless signal transmitted from the GPS phone 110 through the base station 120 and updates position information stored in the server 153, as shown at step S22. The GPS phone 110 transmits identification data and position confirmation data at regular intervals when in an “ON” power state. Accordingly, it is possible to track an accurate position of the GPS phone 110.

Next, the user of the GPS phone 110 is tracked according to the updated position information of the position information server 153, and it is determined whether the user goes into a certain advertisement service region in which the user is capable of seeing the advertisement medium 160, as shown at step S23.

When it is determined that the user is not in the advertisement service region in which the user is capable of seeing the advertisement medium 160, a present position of the user of the GPS phone 110 is continually tracked until it is determined that the user goes into the advertisement service region. When it is determined that the user goes into the advertisement service region, the personal information stored in the GPS phone 110 is transmitted through the base station 120 within the pertinent region, as shown at step S24.

The transmitted personal information is stored in the database 154, as shown at step S25. Major interests of users of GPS phone(s) 110 are updated in an order of priority in the plurality of personal information collected within the pertinent region, as shown at step S26.

The updated order of priority is compared to the order of priority of the proceeding advertisements, and it is determined whether advertisements within the pertinent region have to be varied, as shown at step S27. The order of priority is determined according to the relative importance of the personal information of the users, and it is determined whether there is a change by comparing the order of priority.

When there is a change, advertisements outputted to the advertisement medium 160 within the pertinent region are changed by reflecting the updated order of priority, as shown at step S28. When there is no change, the proceeding advertisements are maintained and outputted, as shown at step S29. Herein, one or more than one advertisement can be outputted through the advertisement medium 160 according to the order of priority, and various information related to major interests of the users can be additionally outputted according to the order of priority.

For example, if after collecting personal information of users of the GPS phone(s) 110 within an advertisement region, it is determined that baseball is a priority item, the advertisement medium within the pertinent region outputs breaking news and advertisements related to baseball. Accordingly, people watching the news through the advertisement medium 160 can simultaneously connect to the advertisements. In addition, by providing breaking news about baseball as the priority item, the number of people connecting to the advertisement medium 160 can be increased. Accordingly, an efficiency of the advertisement(s) can be improved.

In the intelligent advertisement system and method using a mobile communication terminal in accordance with embodiments of the invention, not only one directional simple advertisement service can be provided but also two directional information exchange services can be performed. That is, the system and method can be applied to searching for people, pets, and lost articles, etc.

As described above, in the intelligent advertisement system and method using a mobile communication terminal in accordance with embodiments of the invention, advertisements reflecting an order of priority of users of GPS phones are provided to advertisement mediums installed in a pertinent region, and advertisements reflecting advertisement demand varied by place and time are provided in real time. Thus, an efficiency of the advertisement(s) can be improved.

In addition, in the intelligent advertisement system and method using a mobile communication terminal in accordance with embodiments of the invention, advertisement demands varied by place and time are databased. Accordingly, an advertisement effect can be easily established and the collected data can be used as marketing information.

The foregoing embodiments and advantages are merely exemplary and are not to be construed as limiting the invention. The present teaching can be readily applied to other types of apparatuses. The description of the invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. An advertisement system using a mobile communication terminal, the improvement comprising wherein advertisements are outputted in real time through an advertisement medium in a region based on a priority determined by collecting major interests of users of GPS (global positioning system) phones tracked by GPS (global positioning system) satellites within the region.

2. The system of claim 1, wherein advertisements are varied according to the priority and when the major interests of the users of the GPS phones are updated, the priority is updated.

3. An advertisement system using one or more mobile communication terminals, comprising:
one or more mobile communication terminals configured to receive and transmit information corresponding to users of the one or more mobile communication terminals;
an advertisement processing unit for collecting the information transmitted from the one or more mobile communication terminals and controlling an output of advertisements according to a priority based on the information; and
an advertisement medium configured to output the advertisements related to the information of the users under the control of the advertisement processing unit.

4. The system of claim 3, wherein the one or more mobile communication terminals each comprises a phone having a GPS receiver tracked by GPS satellites.

5. The system of claim 3, wherein the information comprises personal information of the users.

6. The system of claim 5, wherein the personal information includes major interests of the users.

7. The system of claim 3, wherein the advertisement processing unit continually updates the information of the users of the one or more mobile communication terminals and controls variation of advertisements according to the updated information.

8. The system of claim 3, wherein the advertisement processing unit comprises:
an exchanger configured to communicate with the one or more mobile communication terminals;
a position information server configured to store present position information of the one or more mobile communication terminals;
an information server configured to store advertisements and various information related to the advertisements; and
a database configured to store the information of the users of the one or more mobile communication terminals.

9. The system of claim 8, wherein the position information server, the information server, and the database are configured to be updated continuously.

10. The system of claim 3, wherein the advertisement medium receives and displays advertisements varied in real time reflecting interests of the users of the one or more mobile communication terminals.

11. The system of claim 3, wherein the advertisement medium is one of an information screen, an electronic billboard, a monitor, a plasma display panel, or a liquid crystal display.

12. In an advertisement system having one or more mobile communication terminals, an advertisement processing unit configured to collect information of users of the one or more mobile communication terminals and an advertisement medium configured to display advertisements, an advertisement method, comprising:
determining advertisement demands through users of the one or more mobile communication terminals within a region; and
outputting advertisements through the advertisement medium within the region according to the advertisement demands.

13. The method of claim 12, wherein the advertisements are varied when the advertisement demands are varied.

14. The method of claim 12, wherein the one or more communication terminals each comprises a phone having a GPS receiver tracked by GPS satellites.

15. The method of claim 12, wherein the step of determining advertisement demands comprising:
selecting and storing information of the one or more mobile communication terminals;
collecting the information of the users of the one or more mobile communication terminals; and
and determining a priority for advertisements based on the collected information, and wherein the step of outputting advertisements comprises outputting advertisements based on the priority.

16. The method of claim 15, wherein the information comprises personal information of the users.

17. The method of claim 16, wherein the personal information includes major interests of the users.

18. The method of claim 15, wherein the order of priority is determined according to relative importance in the interests of the users of the mobile communication terminal respectively.

19. An advertisement method using one or more mobile communication terminals, comprising:
selecting and storing information of the one or more mobile communication terminals;
collecting the information of the users of the one or more mobile communication terminals; and
outputting advertisements through an advertisement medium within a region according to an order of priority based on the collected information.

20. The method of claim 19, further comprising:
determining whether the users of the mobile communication terminals go into the region.

21. The method of claim 19, wherein the information comprises personal information of the users.

22. The method of claim 21, wherein the personal information comprises interests of the users.

23. The method of claim 19, wherein the order of priority is determined according to a relative importance in the interests of the users of the mobile communication terminal respectively.

24. The method of claim 19, wherein the one or more mobile communication terminals each comprises a phone having a GPS receiver tracked by GPS satellites.

25. An advertisement method using one or more mobile communication terminals, comprising:
selecting and storing items of information by users of the one or more mobile communication terminals;
judging whether the users of the one or more mobile communication terminals go into a region in which an advertisement medium is installed;
collecting information of the users going into the region;
determining an order of priority in the collected information; and
outputting advertisements to the advertisement medium within the region based on the order of priority.

26. The method of claim 25, wherein the advertisements in the region are varied when the order of priority is varied.

27. The method of claim 25, wherein the information comprises personal information.

28. The method of claim 27, wherein the personal information comprises interests of the users.

29. The method of claim 25, wherein the order of priority is determined according to a relative importance in the interests of the users of the mobile communication terminal respectively.

30. The method of claim 25, wherein the one or more mobile communication terminals each comprises a phone having a GPS receiver tracked by GPS satellites.
